(19) United States
(12) Patent Application Publication
(10) Pub. No.: US 2006/0045193 A1
(43) Pub. Date: Mar. 2, 2006

(54) System, transmitter, method, and computer program product for utilizing an adaptive preamble scheme for multi-carrier communication systems

(75) Inventors: Victor Stolpman, Irving, TX (US); Nico Van Waes, Keller, TX (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/075,976

(22) Filed: Mar. 9, 2005

Related U.S. Application Data
(60) Provisional application No. 60/603,865, filed on Aug. 24, 2004.

(51) Int. Cl. H04K 1/10

(52) U.S. Cl. 375/260

(57) ABSTRACT

A system, transmitter, method, and computer program product apply a performance improvement characteristic, such as phase rotation or power allocation, to both a known preamble and a data payload of a transmitted data packet, such that existing multi-carrier receivers are capable of decoding the data payload with the performance improvement characteristic applied. The performance improvement characteristic is applied by vector-matrix multiplication of the preamble and the data payload by the performance improvement characteristic.

### CROSS-REFERENCE TO RELATED APPLICATIONS

The present application claims priority from U.S. Provisional Application Ser. No. 60/603,865 entitled ADAPTIVE PREAMBLE SCHEME FOR OFDM SYSTEMS EMPLOYING SUB-CARRIER ADAPTIVE POWER CONTROL AND DISABLING, filed Aug. 24, 2004, the contents of which are incorporated herein by reference.

### FIELD OF THE INVENTION

The present invention generally relates to wireless communication and, more particularly, relates to wireless communication using multi-carrier techniques.

### BACKGROUND OF THE INVENTION

Wireless communication involves transmission of encoded information on a modulated radio frequency (RF) carrier signal. Many wireless communication systems use multi-carrier communication techniques, such as orthogonal frequency division multiplexing (OFDM), in which a high speed serial information signal is divided into multiple lower speed subsignals. These subsignals are transmitted by the communication system simultaneously at different frequencies called sub-carriers.

Multi-carrier communication techniques may employ the transmission of known symbols, along with the data to be transmitted, in order to enable the receiver to estimate the characteristics of the channel through which the signal was transmitted. Estimating the characteristics of the channel enable the receiver to properly decode the transmitted data. Communication protocols, such as IEEE 802.11a, may specify what symbols should be transmitted and how the symbols should be transmitted. See, for example, FIG. 1 which illustrates a data packet 100 as may be specified by a communication protocol such as IEEE 802.11a. The data packet 100 comprises a preamble 102, a header 104, and a data payload 106. In the data packet of FIG. 1, the known symbols used by the receiver to estimate the channel would typically be transmitted in the preamble 102, control signaling information would typically be transmitted in the header 104, and the data would be transmitted in the data payload 106.

In order to improve one or more performance characteristics of a wireless communication signal, such as the Peak-to-Average Power Ratio (PAPR), the Bit Error Rate (BER), or the Frame Error Rate (FER), it may be necessary to perform some additional processing of the sub-carriers in the data payload portion of the data packet. For example, phase rotation may be applied to the sub-carriers in order to improve Peak-to-Average-Power-Ratio (PAPR). This is done to reduce the dynamic range that the power amplifiers require and in turn reduce the costs of these said amplifiers. Additionally, power allocation may be applied to the sub-carriers, such that some sub-carriers are amplified and some sub-carriers are de-amplified in order to improve link performance by intelligently placing transmitter energy on sub-carriers to take advantage of the heterogeneous channel response that exists between transmitter and receiver such that the error rate is reduced. When this additional processing is performed at the transmitter, the receiver must know what specific additional processing is performed in order to be able to decode the received signals. For example, the receiver must know what phase rotation was applied to the sub-carriers and/or what power allocation was applied.

One possible method for the receiver to know what additional processing was performed by the transmitter is for the transmitter to use a predefined header format to communicate the actual values (or compressed representations of the actual values) of the sub-carrier phase rotations or power allocations that were used in the data payload portion of the data packet. The values would typically be transmitted in the header (element 104 of FIG. 1) of the data packet. There are, however, at least two disadvantages to this method. Transmitting the actual values of the phase rotations or power allocations uses bandwidth that could otherwise be used for the data being transmitted. Additionally, the receiver must have hardware or software that is capable of receiving, interpreting, and using the values received in the header to decode the data. This precludes using this method to transmit data to existing receivers that typically would not have the necessary hardware and/or software (such a receiver may be termed a legacy receiver). This lack of backward compatibility is a significant disadvantage.

Another possible method for the receiver to know what additional processing was performed by the transmitter is for the receiver to communicate with the transmitter via a feedback channel, such that the receiver instructs the transmitter which phase rotations or power allocations the transmitter should use. As with the previous method, this method has at least two disadvantages. This method is not backward compatible and will therefore not work with legacy receivers. Additionally, the feedback channel requires additional hardware and, as such, adds complexity and cost to the system.

As such, there is a need for a wireless communication system that enables additional processing, such as phase rotation or power allocation, to be performed to the data payload to improve communication performance, while requiring no additional bandwidth and which is backward compatible with legacy receivers.

### BRIEF SUMMARY OF THE INVENTION

A system, transmitter, method, and computer program product are therefore provided in which a performance improvement characteristic is applied to both a known preamble and a data payload such that existing multi-carrier receivers are capable of decoding the data payload with the performance improvement characteristic applied, thereby enabling performance improvement techniques to be used in conjunction with existing multi-carrier receivers.

In this regard, a system comprises a transmitter and a receiver. The transmitter comprises a processing element capable of applying a performance improvement characteristic, such as a unitary rotational transform or a power allocation, to the known preamble and to the data payload prior to transmission of the preamble and the data payload. The processing element of the transmitter may apply the performance improvement characteristic to the known preamble by multiplying a vector representing the known preamble by a matrix representing the performance improvement characteristic. The processing element of the transmitter may apply the performance improvement characteristic to the data payload by multiplying a vector representing the data payload by the matrix representing the performance improvement characteristic.

The receiver comprises a processing element capable of receiving the preamble and the data payload. The processing element of the receiver is further capable of estimating a channel through which the preamble and the data payload were transmitted, and the processing element of the receiver is capable of estimating the performance improvement characteristic. The processing element of the receiver may estimate the channel and the performance improvement characteristic by comparing the received preamble to the known preamble. The processing element of the receiver is also capable of estimating the data payload based on the estimated channel and the estimated performance improvement characteristic.

In one embodiment of the invention, the processing element of the transmitter is capable of applying a second performance improvement characteristic to the preamble and to the data payload, in addition to applying the performance improvement characteristic discussed above (i.e., the first performance improvement characteristic) to the preamble and the data payload. The first performance improvement characteristic may be a power allocation and the second performance improvement characteristic may be a unitary rotational transform.

In addition to the system for wirelessly communicating a data packet comprising a known preamble and a data payload described above, other aspects of the present invention are directed to corresponding transmitters, methods, and computer program products for wirelessly communicating a data packet comprising a known preamble and a data payload.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a diagram of a data packet that may be communicated via embodiments of the present invention;

FIG. 2 is a schematic block diagram of a system capable of wirelessly communicating a data packet comprising a known preamble and a data payload using a multi-carrier signal, in accordance with one embodiment of the present invention;

FIG. 3 is a schematic block diagram of a system capable of wirelessly communicating a data packet comprising a known preamble and a data payload using a multi-carrier signal, in accordance with one embodiment of the present invention; and

FIG. 4 is a flowchart of the operation of wirelessly communicating a data packet comprising a known preamble and a data payload using a multi-carrier signal, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The system, transmitter, method, and computer program product of embodiments of the present invention will be primarily described in conjunction with multi-carrier wireless communication systems using orthogonal frequency division multiplexing (OFDM) complying with the IEEE 802.11a communication protocol. It should be understood, however, that the system, transmitter, method, and computer program product of embodiments of the present invention can be utilized in conjunction with a variety of other multi-carrier communication techniques such as multi-carrier code division multiple access (MC-CDMA). Additionally, the system, transmitter, method, and computer program product of embodiments of the present invention can be utilized in conjunction with multi-carrier wireless systems utilizing multiple transmitting antennas and multiple receiving antennas (termed MIMO systems), as well as systems utilizing a single transmitting antenna and a single receiving antenna (termed SISO systems).

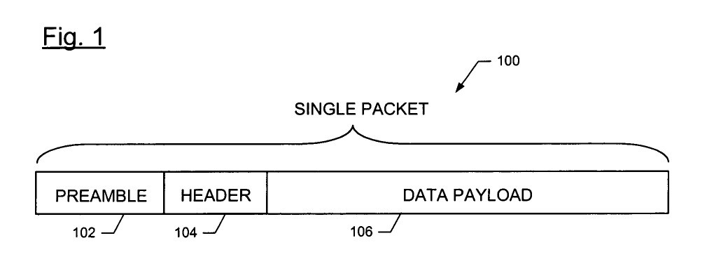

Referring to FIG. 1, an illustration of a data packet that may be communicated via embodiments of the present invention is provided. As discussed above, a data packet 100 may comprise a preamble 102, a header 104, and a data payload 106. The data payload 106 comprises the data to be communicated from the transmitter to the receiver. The preamble 102 comprises the known symbols used by the receiver to estimate the channel through which the data packet 100 was transmitted.

In a typical multi-carrier wireless communication system, the known symbols in the preamble may be expressed as a vector L, the transmitted data in the data payload 106 may be expressed as a vector X, the characteristics of the channel through which the packet is transmitted may be expressed as a matrix H, the additive white Gaussian noise (AWGN) that is also received at the receiver may be expressed as a vector Z, and the received signal may be expressed as a vector Y.

In a typical system, X⁽ⁿ⁾=[X₀⁽ⁿ⁾, X₁⁽ⁿ⁾, . . . , X_{N-1}⁽ⁿ⁾]^{T} is the N modulated frequency-domain sub-carrier symbols for the n^{th} transmit antenna for n=1, 2, . . . , N_{y} where N_{y} is the number of transmit antennas, and T is time. For each sub-carrier k, Xₖ=[Xₖ⁽¹⁾, Xₖ⁽²⁾, . . . , Xₖ^{(N}^{ₜ}⁾]^{T} where E{((Xₖ)^{T})*Xₖ}=Pₖ∀k, where E means expectation (i.e., the statistical average), and where Pₖ is the power allocated to the k^{th} subcarrier. Thus, E{((Xₖ)^{T})*Xₖ}=Pₖ∀k means that, on average, Xₖ has Pₖ power given that Xₖ has a zero mean. Each sub-carrier matrix Xₖ is selected from a multi-dimensional constellation consisting of 2^{b}^{ₖ} points using bₖ bits for k=0, 1, . . . , N−1, and the vector b=[b₀, b₁, . . . , b_{N-1}]^{T} contains the bit-loading assignments and may be either uniform or heterogeneous across sub-carriers. As such, all transmitted frequency-domain symbols may be combined into a single vector written as:
X=[X₀⁽¹⁾,X₀⁽²⁾, . . . ,X₀^{(N}^{ₜ}⁾,X₁⁽¹⁾,X₁⁽²⁾, . . . ,X₁^{(N}^{ₜ}⁾, . . . ,X_{N-1}⁽¹⁾,X_{N-1}⁽²⁾, . . . ,X_{N-1}^{(N}^{ₜ}⁾]^{T}.

In the typical system, Y^{(m)}=[Y₀^{(m)}, Y₁^{(m)}, . . . , Y_{N-1}^{(m)}]^{T} is the N received frequency-domain sub-carrier symbols for the m^{th} receive antenna for m=1, 2, . . . , Nᵣ where Nᵣ is the number of receive antennas. For each sub-carrier, let Yₖ=[Yₖ⁽¹⁾, Yₖ⁽²⁾, . . . , Yₖ^{(N}^{ₜ}⁾]^{T}. Similarly, the complex-valued frequency-domain AWGN may be expressed as Z^{(m)}=[Z₀^{(m)}, Z₁^{(m)}, . . . , Z_{N-1}^{(m)}]^{T} where E{(Zₖ^{(m)})*Zₖ^{(m)}}=N₀∀k, m, where N₀ is the noise power.

Assuming orthogonality is maintained though the use of a long enough cyclic prefix or guard interval (i.e., longer in time duration than the channel's impulse response), the received frequency-domain symbols may be expressed in matrix form as Y=HX+Z, where

$$Y = {[ {Y}_{0}^{( 1 )} , {Y}_{0}^{( 2 )} , … , {Y}_{0}^{( {N}_{r} )} , {Y}_{1}^{( 1 )} , {Y}_{1}^{( 2 )} , … , {Y}_{1}^{( {N}_{r} )} , … , {Y}_{N - 1}^{( 1 )} , {Y}_{N - 1}^{( 2 )} , … , {Y}_{N - 1}^{( {N}_{r} )} ]}^{T} , \\ Z = {[ {Z}_{0}^{( 1 )} , {Z}_{0}^{( 2 )} , … , {Z}_{0}^{( {N}_{r} )} , {Z}_{1}^{( 1 )} , {Z}_{1}^{( 2 )} , … , {Z}_{1}^{( {N}_{r} )} , … , {Z}_{N - 1}^{( 1 )} , {Z}_{N - 1}^{( 2 )} , … , {Z}_{N - 1}^{( {N}_{r} )} ]}^{T} , \\ H = [ \begin{matrix}{H}_{0} & {0}_{( {N}_{r} \times {N}_{t} )} & ⋯ & {0}_{( {N}_{r} \times {N}_{t} )} \\ {0}_{( {N}_{r} \times {N}_{t} )} & {H}_{1} & ⋯ & {0}_{( {N}_{r} \times {N}_{t} )} \\ ⋮ & ⋮ & ⋰ & ⋮ \\ {0}_{( {N}_{r} \times {N}_{t} )} & {0}_{( {N}_{r} \times {N}_{t} )} & ⋯ & {H}_{N - 1}\end{matrix} ] with {H}_{k} = [ \begin{matrix}{H}_{k}^{1 , 1} & {H}_{k}^{1 , 2} & ⋯ & {H}_{k}^{1 , {N}_{t}} \\ {H}_{k}^{2 , 1} & {H}_{k}^{2 , 2} & ⋯ & {H}_{k}^{2 , {N}_{t}} \\ ⋮ & ⋮ & ⋰ & ⋮ \\ {H}_{k}^{{N}_{r} , 1} & {H}_{k}^{{N}_{r} , 2} & ⋯ & {H}_{k}^{{N}_{r} , {N}_{t}}\end{matrix} ] ∀ k ,$$

Hₖ^{m,n} is the k^{th} sub-carrier's response between the n^{th} transmit antenna and the m^{th} receive antenna, and 0_{(N}_{ᵣ}_{×N}_{ₜ}₎ represents an all zeros matrix of dimension (Nᵣ×Nₜ).

As discussed above, the transmitter inserts a preamble structure at the beginning of a transmission burst used by the receiver to extract channel state information (CSI) (e.g., Ĥ, which is an estimate of the channel's state). An example preamble consisting of a single OFDM epoch may be described as L⁽ⁿ⁾=[L₀⁽ⁿ⁾, L₁⁽ⁿ⁾, . . . , L_{N-1}⁽ⁿ⁾]^{T} for n=1, 2, . . . , Nₜ, where L⁽ⁿ⁾ is the N frequency-domain preamble elements to be sent from the n^{th} transmit antenna with elements consisting of a prearranged sequence of the elements in the set

$${L}_{k}^{( n )} ∈ \{ 0 , \frac{\pm 1 \pm j}{\sqrt{{N}_{t}}} \} for k = 0 , 1 , … , N - 1 and n = 1 , 2 , … , {N}_{t} .$$

It should be appreciated that a single OFDM epoch is illustrated for example purposes only. The embodiments of the present invention are not limited to a single OFDM epoch, but rather extend to preambles consisting of multiple OFDM epochs, including those having different sets of active antennas. This example preamble may be written in vector form as
L=[L₀⁽¹⁾, L₀⁽²⁾, . . . , L₀^{(N}^{ₜ}⁾, L₁⁽¹⁾, L₁⁽²⁾, . . . , L₁^{(N}^{ₜ}⁾, . . . , L_{N-1}⁽¹⁾, L_{N-1}⁽²⁾, . . . , L_{N-1}^{(N}^{ₜ}⁾]^{T}.
The received preamble may therefore be expressed as Y_{L}=HL+Z.

As discussed above, the received frequency-domain symbols may be expressed in matrix form as Y=HX+Z. The received preamble (Y_{L}=HL+Z) may be used by a receiver in a typical system to estimate the channel (H), as L is defined by the communication standard and thus is known. The estimated channel may be subsequently used for detection and/or equalization for the received OFDM symbols during subsequent OFDM symbol epochs. The receiver is able to estimate X (the transmitted frequency-domain symbols) by having an estimate of H, and thus the receiver is able to output an estimate of the data that was input to the transmitter.

In the examples described herein, the preamble is transmitted at the beginning of a transmission burst, with the information-bearing OFDM symbols transmitted in subsequent OFDM time epochs. It should be appreciated that this configuration is for illustrative purposes only, and that embodiments of the invention permit the preamble to be transmitted during time epochs other than the beginning of the transmission burst.

As discussed above, additional processing of the data vector (X) may be required to improve the performance of the transmission. This additional processing may be termed a performance improvement characteristic. One type of performance improvement characteristic involves phase rotation of the sub-carrier signals. This type of additional processing may be employed in a MIMO or a SISO configuration. In a MIMO configuration, X, Y, Z, and H are defined as

$$X = {[ {X}_{0}^{( 1 )} , {X}_{0}^{( 2 )} , … , {X}_{0}^{( {N}_{t} )} , {X}_{1}^{( 1 )} , {X}_{1}^{( 2 )} , … , {X}_{1}^{( {N}_{t} )} , … , {X}_{N - 1}^{( 1 )} , {X}_{N - 1}^{( 2 )} , … , {X}_{N - 1}^{( {N}_{t} )} ]}^{T} , \\ Y = {[ {Y}_{0}^{( 1 )} , {Y}_{0}^{( 2 )} , … , {Y}_{0}^{( {N}_{r} )} , {Y}_{1}^{( 1 )} , {Y}_{1}^{( 2 )} , … , {Y}_{1}^{( {N}_{r} )} , … , {Y}_{N - 1}^{( 1 )} , {Y}_{N - 1}^{( 2 )} , … , {Y}_{N - 1}^{( {N}_{r} )} ]}^{T} , \\ Z = {[ {Z}_{0}^{( 1 )} , {Z}_{0}^{( 2 )} , … , {Z}_{0}^{( {N}_{r} )} , {Z}_{1}^{( 1 )} , {Z}_{1}^{( 2 )} , … , {Z}_{1}^{( {N}_{r} )} , … , {Z}_{N - 1}^{( 1 )} , {Z}_{N - 1}^{( 2 )} , … , {Z}_{N - 1}^{( {N}_{r} )} ]}^{T} , and$$

$$H = [ \begin{matrix}{H}_{0} & {0}_{( {N}_{r} \times {N}_{t} )} & ⋯ & {0}_{( {N}_{r} \times {N}_{t} )} \\ {0}_{( {N}_{r} \times {N}_{t} )} & {H}_{1} & ⋯ & {0}_{( {N}_{r} \times {N}_{t} )} \\ ⋮ & ⋮ & ⋰ & ⋮ \\ {0}_{( {N}_{r} \times {N}_{t} )} & {0}_{( {N}_{r} \times {N}_{t} )} & ⋯ & {H}_{N - 1}\end{matrix} ] with {H}_{k} = [ \begin{matrix}{H}_{k}^{1 , 1} & {H}_{k}^{1 , 2} & ⋯ & {H}_{k}^{1 , {N}_{t}} \\ {H}_{k}^{2 , 1} & {H}_{k}^{2 , 2} & ⋯ & {H}_{k}^{2 , {N}_{t}} \\ ⋮ & ⋮ & ⋰ & ⋮ \\ {H}_{k}^{{N}_{r} , 1} & {H}_{k}^{{N}_{r} , 2} & ⋯ & {H}_{k}^{{N}_{r} , {N}_{t}}\end{matrix} ] ∀ k .$$

A family of unity matrices used in a MIMO configuration may be defined as

$$R = [ \begin{matrix}{R}_{0} & {0}_{( {N}_{t} \times {N}_{t} )} & ⋯ & {0}_{( {N}_{t} \times {N}_{t} )} \\ {0}_{( {N}_{t} \times {N}_{t} )} & {R}_{1} & ⋯ & {0}_{( {N}_{t} \times {N}_{t} )} \\ ⋮ & ⋮ & ⋰ & ⋮ \\ {0}_{( {N}_{t} \times {N}_{t} )} & {0}_{( {N}_{t} \times {N}_{t} )} & ⋯ & {R}_{N - 1}\end{matrix} ]$$

$$with {( {( {R}_{k} )}^{T} )}^{*} {R}_{k} = {I}_{( {N}_{t} \times {N}_{t} )} ∀ k .$$

Rₖ is a unitary matrix as defined by ((Rₖ)^{T})*Rₖ=I_{(N}_{ₜ}_{×N}_{ₜ}₎∀k. I is the identity matrix (i.e., a square matrix with 1 along the main diagonal and 0 along in all locations off the main diagonal). These matrices are capable of performing multi-dimensional rotations on information data within individual sub-carriers by a vector-matrix multiplication in the form of Y=HRX+Z. Because all Rₖ are unitary ∀k, this operation does not alter the aggregate transmitter power.

The motivation for performing such a phase rotation varies. For example, a particular set of phase rotations may reduce the PAPR of a corresponding frequency-domain data symbol set. Alternatively, unitary rotational transforms may be used to manipulate the transmit signal such that the transmit signal is within the span of the channel's subspace.

In addition to the MIMO configuration discussed above, phase rotations may also be performed where a single transmit antenna is used. For a single transmit antenna (i.e., Nₜ=1), φₖ may denote the phase rotation to the k^{th} sub-carrier by the transmitter, such that the received signal at the m^{th} receive antenna becomes
Yₖ^{(m)}=HₖXₖe^{jφ}^{ₜ}+Zₖ for k=0, 1, . . . , N−1 and m=1, 2, . . . , Nᵣ.
This may be written in vector form as Y=HRX+Z where

$$R = [ \begin{matrix}{ⅇ}^{{jϕ}_{0}} & 0 & ⋯ & 0 \\ 0 & {ⅇ}^{{jϕ}_{1}} & ⋯ & 0 \\ ⋮ & ⋮ & ⋰ & ⋮ \\ 0 & 0 & ⋯ & {ⅇ}^{{jϕ}_{N - 1}}\end{matrix} ] and j = \sqrt{- 1} .$$

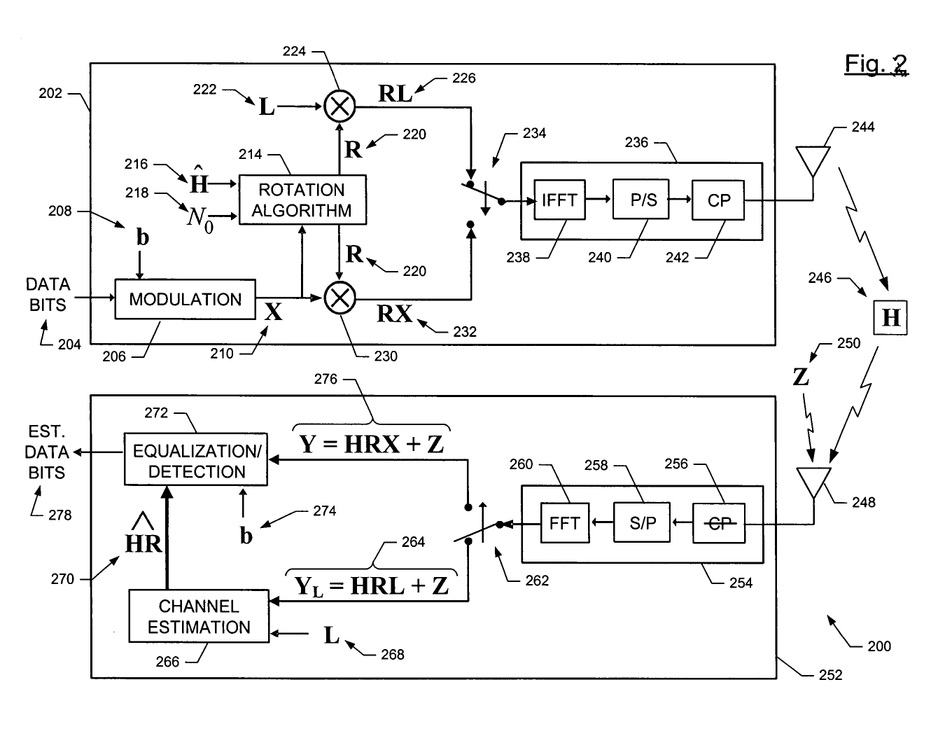

When the transmitter applies phase rotations to the information data (i.e., to X), the transmitter must convey the rotations to the receiver to enable the receiver to detect the intended message properly. Referring now to FIG. 2, a block diagram of a system capable of wirelessly communicating a data packet comprising a known preamble and a data payload using a multi-carrier signal, is shown in accordance with one embodiment of the present invention. The system of FIG. 2 enables a transmitter to convey the phase rotations to a receiver, thus enabling the receiver to decode the phase rotated data.

The system 200 of FIG. 2 comprises a transmitter 202, a transmit antenna 244, a receiver 252, and a receive antenna 248. Data bits 204 to be transmitted are input to a modulation element 206 in the receiver 202. The modulation element 206, using the bit-loading assignments expressed by the vector b 208, modulates the data bits 204 into frequency-domain symbols of the data, expressed by the vector X 210. The vector b may be defined within a communication standard or a bit loading algorithm that is determined by the system's designer to improve system performance. A rotation algorithm 214 may be used to determine the phase rotation matrix R 220, which expresses the phase rotation necessary to provide the desired performance improvement for all sub-carriers. An estimate of the channel 216 (Ĥ), a noise power value 218 (N₀), and the modulated data 210 (X) may be used by the rotation algorithm 214 to determine the appropriate phase rotation matrix 220. The rotation algorithm will choose a unitary matrix according to the design criteria of choice (e.g., to minimize PAPR or to minimize the cordial distance from the channel's subspace). The receiver would typically execute a channel estimation algorithm chosen by the receiver's designer to estimate the channel. For example, the receiver's designer may choose to have the receiver execute a least-squares estimator or a minimum mean squared error estimator. The method by which the rotation algorithm determines the phase rotation matrix would typically depend on the choice of rotation algorithm and the selection criteria used to choose the rotation algorithm. For example, if minimizing PAPR is the selection criteria, the algorithm chosen by the designer will typically use the modulated data to select the rotation matrix that minimizes the PAPR. For channel sub-space tracking, the algorithm chosen by the designer would most likely use the channel and the noise power to determine the rotation matrix that is closest to the subspace spanned by the channel, which may be measured by some distance criteria.

The phase rotation may be applied to the modulated data X by multiplying X by R, as discussed above, using a multiplication element 230. The output of the multiplication element 230 is RX 232, which represents the phase rotated data. This phase rotated data would have the desired improved performance characteristic when transmitted. However, a legacy receiver would not be able to decode the data unless the receiver knows how the data was phase rotated.

The embodiments of the present invention provide the phase rotation information by similarly phase rotating the preamble. As shown in FIG. 2, the preamble 222 (L) may also be multiplied by the same phase rotation matrix 220 using a multiplication element 224. The output of the multiplication element 224 is RL 226, which represents the phase rotated preamble. The preamble 222 would typically be stored in non-volatile memory within transmitter 202. The transmitter 202 would typically transmit the phase rotated preamble RL and then transmit the phase rotated data RX. The sequence of the transmission of RL and RX may be controlled by switch 234, by selectively switching either the output of the multiplication element 224 (thereby transmitting RL) or the output of the multiplication element 230 (thereby transmitting RX) to the output of the transmitter 202. It should be appreciated that switch 234 in FIG. 2 could be any suitable hardware or software switching mechanism known to those skilled in the art.

The output of switch 234 would typically be input to an OFDM back end 236 which processes the signal for transmission. If a multi-carrier communication technique other than OFDM is used, a different back end processing element would typically be used. The OFDM back end 236 comprises an Inverse Fast Fourier Transform (IFFT) element 238, a Parallel-to-Serial (P/S) element 240, and a Cyclic Prefix (CP) element 242. The IFFT element 238 transforms the frequency domain symbols into time domain symbols for each transmit antenna. The P/S element 240 converts the time domain symbols from parallel to serial. The CP element 242 concatenates a cyclic prefix to the time domain symbols as required by the OFDM format.

The output of the OFDM back end 236 is transmitted via transmit antenna 244. The transmitted signal travels through a channel 246 (H) until the signal reaches a receive antenna 248. AWGN 250 (Z) is also received by the receive antenna 248. It should be appreciated that the AWGN 250 is a random noise input. As such, the AWGN 250 will typically vary for each received signal.

The receive antenna 248 is connected to receiver 252. The received time domain signal is input to an OFDM front end 254, which comprises a Cyclic Prefix removal (CP) element 256, a Serial-to-Parallel (S/P) element 258, and a Fast Fourier Transform (FFT) element 260. The CP element 256 removes the concatenated cyclic prefix. The S/P element 258 converts the time domain symbols from serial to parallel. The FFT element 260 transforms the time domain symbols to frequency domain symbols.

The received signal is output from the OFDM front end 254 to a switch 262. Switch 262 directs the received phase rotated preamble signal 264 (Y_{L}) to that portion of the receiver 252 capable of using the received preamble to estimate the channel and directs the received phase rotated data signal (Y) to that portion of the receiver 252 capable of detecting the transmitted data (X), as discussed below. It should be appreciated that switch 262 in FIG. 2 could be any suitable hardware or software switching mechanism known to those skilled in the art.

The received phase rotated preamble signal 264 (Y_{L}, which equals HRL+Z) is directed by the switch 262 to a channel estimation element 266. The known preamble 268 (L) is also input to the channel estimation element 266. The preamble 268 would typically be stored in non-volatile memory within the receiver 252. As with the transmitter, the preamble that is stored in the receiver is the preamble defined by the communication standard to be used by the transmitter and the receiver. Using the known preamble 268 and the received phase rotated preamble 264, the channel estimation element 266 is advantageously able to estimate the effective CSI 270 (\hat{HR}). Effective CSI 270 is the estimate of the channel combined with the phase rotation.

The received phase rotated data signal 276 (Y, which equals HRX+Z) may be directed by the switch 262 to an equalization/detection element 272. The equalization/detection element 272 is capable of using the effective CSI 270, the bit loading vector 274 (b), and the received rotated data signal 276 to determine an estimate of the received data vector X. The vector b used by the receiver is the same b that is used by the transmitter, and therefore may be defined within a communication standard or a bit loading algorithm that is determined by the system's designer to improve system performance. The equalization/detection element 272 of the receiver estimates X using a detection algorithm, such as minimum distance, likelihood ratio, log-likelihood ratio, or the like. The equalization/detection element 272 is then capable of demodulating the estimate of X to determine an estimate of the data bits 278. The receiver 252 is therefore able to use the phase rotated preamble to determine the phase rotation, which in turn is used to decode the phase rotated data signal. As such, phase rotation may be applied to a transmitted data signal to improve transmission performance and a legacy receiver may be capable of decoding such a phase rotated data signal, without additional bandwidth or a feedback channel required.

It should be appreciated that the functions described above that are performed within the transmitter 202 may be performed by one or more processors or other processing elements within the transmitter. Similarly, the functions described above that are performed within the receiver 252 may be performed by one or more processors or other processing elements within the receiver.

In addition to applying phase rotation to a transmitted data signal, additional methods exist to improve the performance of the transmission. One additional method is to apply power allocation or power loading to the transmitted data signal. As discussed above, power allocation may be applied to the sub-carriers, such that some sub-carriers are amplified and some sub-carriers are de-amplified. This type of additional processing also may be employed in a MIMO or a SISO configuration.

Where the CSI is known at the transmitter, the transmitter may apply adaptive bit-loading and power-loading across the sub-carriers. If Pₖ denotes the power allocated to the k^{th} sub-carrier by the transmitter, the received signal becomes Yₖ=\sqrt{Pₖ}HₖXₖ+Zₖ for k=0, 1, . . . , N−1. This could be written in vector form as Y=HP^{1/2}X+Z where

$${P}^{1 / 2} = [ \begin{matrix}\sqrt{{P}_{0}} & 0 & ⋯ & 0 \\ 0 & \sqrt{{P}_{1}} & ⋯ & 0 \\ ⋮ & ⋮ & ⋰ & ⋮ \\ 0 & 0 & ⋯ & \sqrt{{P}_{N - 1}}\end{matrix} ] .$$

As above, the prearranged, frequency-domain preamble for the OFDM system may be expressed as L=[L₀, L₁, . . . , L_{N-1}]^{T}, consisting of a prearranged sequence of the elements in the set Lₖε{±1} for k=0, 1, . . . , N−1. In the embodiments of the present invention, the transmitter performs power loading on the preamble for conveying information defining the power distribution across sub-carriers that the transmitter has performed/will perform on the data payload portion of the data packet. As such, the preamble that is received by the receiver, after power loading by the transmitter and transmission through the channel, is Yₖ=\sqrt{Pₖ}HₖLₖ+Zₖ for k=0, 1, . . . , N−1 which could be written in vector form as Y_{L}=HP^{1/2}L+Z.

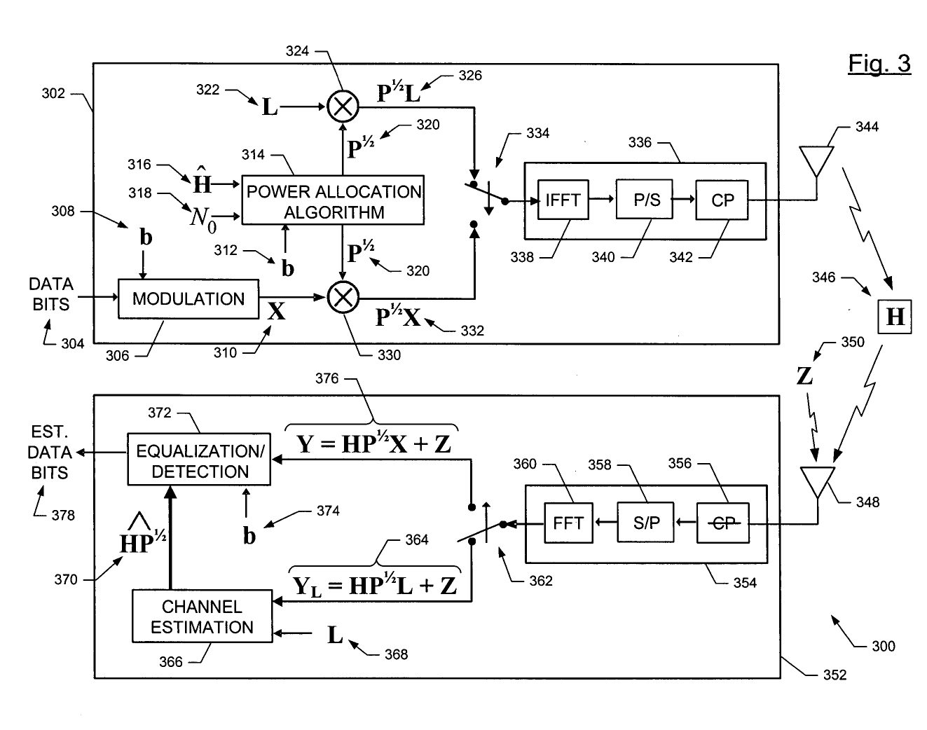

When the transmitter applies power allocation to the information data (i.e., to X), the receiver must know the power allocation that has been applied in order for the receiver to detect the intended message properly. Referring now to FIG. 3, a block diagram of a system capable of wirelessly communicating a data packet comprising a known preamble and a data payload using a multi-carrier signal, is shown in accordance with one embodiment of the present invention. The system of FIG. 3 enables a transmitter to convey the power allocation to a receiver, thus enabling the receiver to decode the power allocated data.

The system 300 of FIG. 3 comprises a transmitter 302, a transmit antenna 344, a receiver 352, and a receive antenna 348. Data bits 304 to be transmitted are input to a modulation element 306 in the receiver 302. The modulation element 306, using the bit-loading assignments expressed by the vector b 308, modulates the data bits 304 into frequency-domain symbols of the data, expressed by the vector X 310. A power allocation algorithm 314 may be used to determine the power allocation matrix P^{1/2} 320, which expresses the power allocation necessary to provide the desired performance improvement for all sub-carriers. An estimate of the channel 316 (Ĥ), a noise power value 318 (N₀), and the bit loading vector 312 (b) may be used by the power allocation algorithm 314 to determine the appropriate power allocation matrix 320. The power algorithm optimizes the power distribution across sub-carriers according to some criteria chosen by the designer (e.g. to minimize the average symbol error or to minimize the maximum sub-carrier bit error rate). A number of algorithms for power loading are known to those skilled in the art. The channel estimate may be determined from a previous reception of a signal, by using explicit feedback, or by other techniques known to those skilled in the art. The power allocation algorithm will generally calculate the power allocation according to the designer's choice of the power loading algorithm, with the algorithm typically using the bit profile b, the CSI Ĥ, and the noise power N₀ as inputs. The power loading is a process selected by the designer of the system. Any number of power loading algorithms may be used, as are known to those skilled in the art, such that the system may efficiently convey the power distribution.

The power allocation may be applied to the modulated data X by multiplying X by P^{1/2} using a multiplication element 330, as discussed above. The output of the multiplication element 330 is P^{1/2}X 332, which represents the power allocated data. This power allocated data would have the desired improved performance characteristic when transmitted. However, a legacy receiver would not be able to decode the data unless the receiver knows how the data was power allocated.

Embodiments of the present invention provide the power allocation information by similarly power allocating the preamble. As shown in FIG. 3, the preamble 322 (L) may also be multiplied by the same power allocation matrix 320 using a multiplication element 324. The output of the multiplication element 324 is P^{1/2}L 326, which represents the power allocated preamble. The preamble 322 would typically be stored in non-volatile memory within the transmitter 302. The transmitter 302 would typically transmit the power allocated preamble P^{1/2}L and then transmit the power allocated data P^{1/2}X. The sequence of the transmission of P^{1/2}L and P^{1/2}X may be controlled by switch 334, by selectively switching the output of the multiplication element 324 (thereby transmitting P^{1/2}L) or the output of the multiplication element 330 (thereby transmitting P^{1/2}X) to the output of the transmitter 302. It should be appreciated that switch 334 in FIG. 3 could be any suitable hardware or software switching mechanism known to those skilled in the art.

The output of switch 334 would typically be input to an OFDM back end 336 which processes the signal for transmission. If a multi-carrier communication technique other than OFDM is used, then a different back end processing element would typically be used. The OFDM back end 336 comprises an Inverse Fast Fourier Transform (IFFT) element 338, a Parallel-to-Serial (P/S) element 340, and a Cyclic Prefix (CP) element 342. The IFFT element 338 transforms the frequency domain symbols into time domain symbols for each transmit antenna. The P/S element 340 converts the time domain symbols from parallel to serial. The CP element 342 concatenates a cyclic prefix to the time domain symbols as required by the OFDM format.

The output of the OFDM back end 336 is transmitted via transmit antenna 344. The transmitted signal travels through a channel 346 (H) until the signal reaches a receive antenna 348. AWGN 350 (Z) is also received by the receive antenna 348. It should be appreciated that the AWGN 350 is a random noise input. As such, the AWGN 350 will typically vary for each received signal.

The receive antenna 348 is connected to receiver 352. The received time domain signal is input to an OFDM front end 354, which comprises a Cyclic Prefix removal (CP) element 356, a Serial-to-Parallel (S/P) element 358, and a Fast Fourier Transform (FFT) element 360. The CP element 356 removes the concatenated cyclic prefix. The S/P element 358 converts the time domain symbols from serial to parallel. The FFT element 360 transforms the time domain symbols to frequency domain symbols.

The received signal is output from the OFDM front end 354 to a switch 362. Switch 362 directs the received power allocated preamble signal 364 (Y_{L}) to that portion of the receiver 352 capable of using the received preamble to estimate the channel and directs the received power allocated data signal (Y) to that portion of the receiver capable of detecting the transmitted data (X), as discussed below. It should be appreciated that switch 362 in FIG. 3 could be any suitable hardware or software switching mechanism known to those skilled in the art.

The received power allocated preamble signal 364 (Y_{L}, which equals HP^{1/2}L+Z) is directed by the switch 362 to a channel estimation element 366. The known preamble 368 (L) is also input to the channel estimation element 366. The preamble 368 would typically be stored in non-volatile memory within the receiver 352. As with the transmitter, the preamble that is stored in the receiver is the preamble defined by the communication standard to be used by the transmitter and the receiver. Using the known preamble 368 and the received power allocated preamble 364, the channel estimation element 366 is advantageously able to estimate the effective CSI 370 (\hat{HP}^{1/2}). Effective CSI 370 is the estimate of the channel combined with the power allocation.

The received power allocated data signal 376 (Y, which equals HP^{1/2}X+Z) may be directed by the switch 362 to an equalization/detection element 372. The equalization/detection element 372 is capable of using the effective CSI 370, the bit loading vector 374 (b), and the received power allocated data signal 376 to determine an estimate of the received data vector X. The vector b used by the receiver is the same b that is used by the transmitter, and therefore may be defined within a communication standard or a bit loading algorithm that is determined by the system's designer to improve system performance. The equalization/detection element 372 of the receiver estimates X using a detection algorithm, such as minimum distance, likelihood ratio, log-likelihood ratio, or the like. The equalization/detection element 372 is then capable of demodulating the estimate of X to determine an estimate of the data bits 378. The receiver 352 is therefore able to use the power allocated preamble to determine the power allocation which, in turn, is used to decode the power allocated data signal. As such, power allocation may be applied to a transmitted data signal to improve transmission performance and a legacy receiver may be capable of decoding such a power allocated data signal, without additional bandwidth required to transmit the power allocation information and without the use of feedback signaling. Because embodiments of the present invention do not require any changes at the receiver, embodiments of the present invention are backward compatible with legacy receivers while still offering the improved benefits associated with sub-carrier adaptation.

It should be appreciated that the functions described above that are performed within the transmitter 302 may be performed by one or more processors or other processing element within the transmitter. Similarly, the functions described above that are performed within the receiver 352 may be performed by one or more processors or other processing elements within the receiver.

It should also be appreciated that both phase rotation and power allocation may be performed to a preamble and a data signal prior to transmission in alternative embodiments of the present invention. Typically, in such an alternative embodiment, the power allocation would be performed by a power allocation algorithm and then the phase rotation would be performed by a phase rotation algorithm. In such a situation, the preamble received at the receiver would be expressed as Y_{L}=HRP^{1/2}L+Z and the data received at the receiver would be expressed as Y=HRP^{1/2}X+Z. The effective CSI estimated by the channel estimation element would be expressed as HRP^{1/2}, and the receiver could use the effective CSI to estimate X. As in the embodiments described in FIGS. 2 and 3, in embodiments in which both phase rotation and power allocation are applied to the transmitted signal, the receiver is capable of estimating the received data bits without additional bandwidth or feedback signaling.

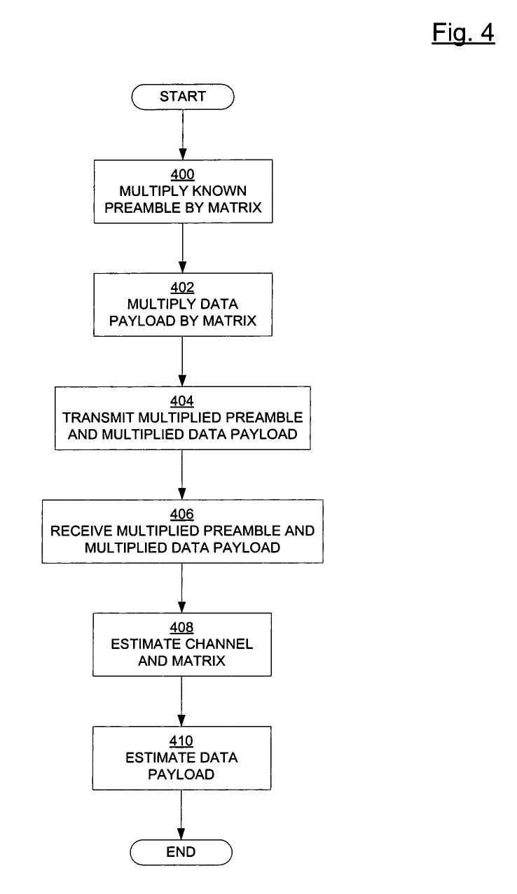

FIG. 4 is a flowchart of the operation of wirelessly communicating a data packet comprising a known preamble and a data payload using a multi-carrier signal, in accordance with one embodiment of the present invention. As shown in block 400 of FIG. 4, the known preamble is multiplied by a matrix representing the performance improvement characteristic, such as power allocation and phase rotation. The data payload is also multiplied by the same matrix representing the same performance improvement characteristic, as shown in block 402. As shown in block 404, the multiplied preamble and the multiplied data payload are transmitted using a multi-carrier wireless communication technique, such as OFDM. The multiplied preamble and the multiplied data payload are received, as shown in block 406. The received preamble is used to estimate the channel through which the signal was transmitted and to estimate the matrix used to represent the performance improvement characteristic, as shown in block 408. With the estimate of the channel and the matrix, the data payload is estimated as shown in block 412.

The method of configuring a data packet comprising a known preamble and a data payload for transmission using a multi-carrier signal and for evaluating the data packet following its receipt may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device and executed by an associated processing unit, such as the processing element of the server.

In this regard, FIG. 4 is a flowchart of methods and program products according to the invention. It will be understood that each step of the flowchart, and combinations of steps in the flowchart, can be implemented by computer program instructions. These computer program instructions may be loaded onto one or more computers or other programmable apparatus to produce a machine, such that the instructions which execute on the computer or other programmable apparatus create means for implementing the functions specified in the flowchart step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart step(s).

Accordingly, steps of the flowchart support combinations of means for performing the specified functions, combinations of steps for performing the specified functions and program instruction means for performing the specified functions. It will also be understood that each step of the flowchart, and combinations of steps in the flowchart, can be implemented by special purpose hardware-based computer systems which perform the specified functions or steps, or combinations of special purpose hardware and computer instructions.

The system, transmitter, method, and computer program product of the present invention enable a performance improvement characteristic to be applied to data that is transmitted wirelessly by applying the same performance improvement characteristic to the preamble, thereby enabling the receiver of the data to decode the received data. As such, a performance improvement characteristic may be applied to transmitted data without the use of additional bandwidth or a feedback channel, and a legacy receiver is able to receive and decode such data.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system for wirelessly communicating a data packet comprising a known preamble and a data payload using a multi-carrier signal, the system comprising:
a transmitter comprising a processing element capable of applying a performance improvement characteristic to the known preamble and to the data payload prior to transmission of the preamble and the data payload; and
a receiver comprising a processing element capable of receiving the preamble and the data payload, the processing element further capable of estimating a channel through which the preamble and the data payload were transmitted and estimating the performance improvement characteristic, wherein both estimations are based on comparing the received preamble to the known preamble, the processing element further capable of estimating the data payload based on the estimated channel and the estimated performance improvement characteristic.

2. The system of claim 1, wherein the processing element of the transmitter applies the performance improvement characteristic to the known preamble by multiplying a vector representing the known preamble by a matrix representing the performance improvement characteristic, and wherein the processing element of the transmitter applies the performance improvement characteristic to the data payload by multiplying a vector representing the data payload by the matrix representing the performance improvement characteristic.

3. The system of claim 1, wherein the performance improvement characteristic is a unitary rotational transform.

4. The system of claim 1, wherein the performance improvement characteristic is a power allocation.

5. The system of claim 1, wherein the processing element of the transmitter is further capable of applying a second performance improvement characteristic to the preamble and applying the second performance improvement characteristic to the data payload, wherein the performance improvement characteristic is a power allocation and the second performance improvement characteristic is a unitary rotational transform.

6. A transmitter for wirelessly communicating a data packet comprising a known preamble and a data payload using a multi-carrier signal, the transmitter comprising:
a processing element capable of applying a performance improvement characteristic to the known preamble and to the data payload prior to transmission of the preamble and the data payload.

7. The transmitter of claim 6, wherein the processing element applies the performance improvement characteristic to the known preamble by multiplying a vector representing the known preamble by a matrix representing the performance improvement characteristic, and wherein the processing element applies the performance improvement characteristic to the data payload by multiplying a vector representing the data payload by the matrix representing the performance improvement characteristic.

8. The transmitter of claim 6, wherein the performance improvement characteristic is a unitary rotational transform.

9. The transmitter of claim 6, wherein the performance improvement characteristic is a power allocation.

10. The transmitter of claim 6, wherein the processing element is further capable of applying a second performance improvement characteristic to the preamble and applying the second performance improvement characteristic to the data payload, wherein the performance improvement characteristic is a power allocation and the second performance improvement characteristic is a unitary rotational transform.

11. A method for wirelessly communicating a data packet comprising a known preamble and a data payload using a multi-carrier signal, the method comprising:
applying a performance improvement characteristic to the known preamble;
applying the performance improvement characteristic to the data payload; and
transmitting the preamble and the data payload.

12. The method of claim 11, wherein applying the performance improvement characteristic to the known preamble comprises multiplying a vector representing the known preamble by a matrix representing the performance improvement characteristic, and wherein applying the performance improvement characteristic to the data payload comprises multiplying a vector representing the data payload by the matrix representing the performance improvement characteristic.

13. The method of claim 11, wherein the performance improvement characteristic is a unitary rotational transform.

14. The method of claim 11, wherein the performance improvement characteristic is a power allocation.

15. The method of claim 11, further comprising:
applying a second performance improvement characteristic to the preamble; and
applying the second performance improvement characteristic to the data payload,
wherein the performance improvement characteristic is a power allocation and the second performance improvement characteristic is a unitary rotational transform.

16. The method of claim 11, further comprising:
receiving the preamble and the data payload;
estimating a channel through which the preamble and the data payload were transmitted and estimating the performance improvement characteristic, wherein both estimations are based on comparing the received preamble to the known preamble; and
estimating the data payload based on the estimated channel and the estimated performance improvement characteristic.

17. A computer program product for wirelessly communicating a data packet comprising a known preamble and a data payload using a multi-carrier signal on a transmitter adapted to enable wireless communication, the computer program product comprising at least one computer-readable storage medium having computer-readable program code portions stored therein, the computer-readable program code portions comprising:
a first executable portion capable of applying a performance improvement characteristic to the known preamble;
a second executable portion capable of applying the performance improvement characteristic to the data payload; and
a third executable portion capable of transmitting the preamble and the data payload.

18. The computer program product of claim 17, wherein the first executable portion applies the performance improvement characteristic to the known preamble by multiplying a vector representing the known preamble by a matrix representing the performance improvement characteristic, and wherein the second executable portion applies the performance improvement characteristic to the data payload by multiplying a vector representing the data payload by the matrix representing the performance improvement characteristic.

19. The computer program product of claim 17, wherein the performance improvement characteristic is a unitary rotational transform.

20. The computer program product of claim 17, wherein the performance improvement characteristic is a power allocation.

21. The computer program product of claim 17, further comprising:
a fourth executable portion capable of applying a second performance improvement characteristic to the preamble; and
a fifth executable portion capable of applying the second performance improvement characteristic to the data payload, wherein the performance improvement characteristic is a power allocation and the second performance improvement characteristic is a unitary rotational transform.
